(19) United States
(12) Patent Application Publication
(10) Pub. No.: US 2008/0288600 A1
(43) Pub. Date: Nov. 20, 2008

(54) APPARATUS AND METHOD FOR PROVIDING ACCESS TO ASSOCIATED DATA RELATED TO PRIMARY MEDIA DATA VIA EMAIL

(76) Inventor: Christopher M. Clark, Knoxville, TN (US)

Correspondence Address: LUEDEKA, NEELY & GRAHAM, P.C., P O BOX 1871, KNOXVILLE, TN, 37901, US

(21) Appl. No.: 12/171,879

(22) Filed: Jul. 11, 2008

Related U.S. Application Data
(63) Continuation-in-part of application No. 11/253,195, filed on Oct. 18, 2005.
Application No. 11/253,195 is a continuation-in-part of application No. 11/559,922, filed on Nov. 15, 2006.

(51) Int. Cl. G06F 15/16

(52) U.S. Cl. 709/206

(57) ABSTRACT

Systems are described for distributing supplemental data to media recipients that are experiencing a primary media event, such as a television or radio program, a movie or a live event. One of the methods includes receiving a media data stream from a media data source, where the media data stream includes primary data and associated data. The primary data includes a primary media presentation, such as a television program or commercial, and the associated data indicates availability of supplemental information related to the program or commercial. As the primary media presentation is presented to the media recipient via a media presentation device, the associated data is accessed from the media data stream. Based on the associated data, an indication is provided to the media recipient indicating that supplemental information is available. This indication may be in the form of a graphic icon that appears on a television screen or other display device. If the media recipient is interested in receiving the supplemental information, the media recipient activates a button on a remote control or other device which causes generation of a request for delivery of the supplemental information. In response to the request, the supplemental information is sent in an email message to the media recipient's email address. For example, the supplemental information may be an audio or video file, a document, or a link to a website which provides more information about a product depicted in the primary media presentation.

This application claims priority as a continuation-in-part to U.S. patent application Ser. Nos. 11/253,195 filed Oct. 18, 2005, titled TELEVISION INTERFACE SYSTEM and 11/559,922 filed Nov. 15, 2006, titled APPARATUS AND METHOD FOR PROVIDING ACCESS TO ASSOCIATED DATA RELATED TO PRIMARY MEDIA DATA.

### FIELD

This invention relates to the field of media data transfer and presentation. More particularly, this invention relates to a system for providing access to associated data that is related to primary media data.

### BACKGROUND

Media outlets are continuously seeking new and unique ways to provide information to media consumers. In particular, media outlets are always seeking innovative ways to provide an advertiser's message to a potential consumer in a way that attracts the consumer's attention and prompts the consumer to seek further information about an advertised product or service. The current challenge is to present advertising information without relying completely upon traditional methods, such as annoying strings of commercials sandwiched between segments of a television or radio program. One approach has been “product placement” in movies and television shows, wherein an advertiser's product is featured prominently within a scene in a movie or television program. Although this approach has been effective in getting consumers to notice the advertiser's product, the amount of product information that can be conveyed in this manner is limited. It would be desirable to provide the consumer an easy and enjoyable way to access further information about the advertised product or service, such as by accessing information on a website or receiving information via email.

What is needed is a way to direct a consumer to additional information regarding a product or service while the consumer is experiencing a media program or event, so that the consumer can seek out the additional information, either during the program or event, or thereafter.

### SUMMARY

To meet the above and other needs, various embodiments of the invention provide apparatuses and methods for distributing associated data to media recipients that are experiencing a primary media event, such as a television or radio program, satellite radio programming, a DVD movie, a cinematic movie or a live event. The associated data may comprise links used by the media recipients to access supplemental information, such as an email or a website accessible via the Internet, that is in some way associated with or related to the primary media event. Because the links lead the media recipients directly to the supplemental information, the media recipients do not need to search for the supplemental information on their own.

In various embodiments of the invention, a direct link is transmitted to a communication device that uses the link to access the supplemental information. In some situations, the direct link is extracted or copied from a data stream that carries the primary media data to the media recipient. Thus, embodiments of the invention extract associated data from a “one-way” primary media data stream and use the associated data to interactively access supplemental information from a “two-way” information medium, such as the Internet or wireless communication networks. In this way, the invention provides a way for one-way media, such as television, radio, movies and videos, to patch into the two-way media, such as the Internet and wireless communication networks.

The presentation of the primary media data can be thought of as a “lean back” sort of experience which is not substantially interactive. However, use of the direct links provide a “lean forward” or interactive experience which enhances the primary media event as the media recipient uses the links to access the supplemental information.

In a preferred embodiment, the invention provides a method for transferring media information from a media data source to a media recipient. The method of this embodiment includes the following steps:
(a) receiving a media data stream from the media data source, where the media data stream includes primary data and associated data, where the primary data includes a primary media presentation and the associated data indicates availability of supplemental information;
(b) presenting the primary media presentation to the media recipient via a media presentation device;
(c) accessing the associated data in the media data stream;
(d) based on the associated data, providing an indication to the media recipient via the media presentation device that supplemental information is available;
(e) sending a request for delivery of the supplemental information; and
(f) sending the supplemental information in an electronic mail message to an email address associated with the media recipient.

In some preferred embodiments, the request of step (e) includes a media recipient identifier, and step (f) includes accessing a database of email addresses to determine an email address associated with the media recipient identifier. In some embodiments, step (f) includes accessing a database of zip codes to determine a zip code associated with the media recipient identifier, and determining content to be included in the electronic mail message based on the zip code associated with the media recipient identifier. In some embodiments, step (f) includes determining content to be included in the electronic mail message based on media consumption data associated with the media recipient identifier. In some embodiments, step (f) includes determining content to be included in the electronic mail message based on whether a user account associated with the media recipient identifier is authorized for monetary purchases of items described in the supplemental information. In some embodiments, step (f) includes determining content to be included in the electronic mail message based on whether the media data stream comprises live programming or recorded programming.

The media data source may be a satellite television data source, a cable television data source, a streaming video data source, a Digital Versatile Disk (DVD) player, a Blue-ray disk player, a satellite radio data source, a terrestrial radio data source, a streaming audio data source, a Compact Disk (CD) player, a personal media player, or a computer hard drive.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a functional block diagram of an apparatus for providing access to associated data related to primary media data according to a preferred embodiment of the invention;

FIG. 2 depicts a flow diagram of a method for providing access to associated data related to primary media data according to a preferred embodiment of the invention;

FIG. 3 depicts a flow diagram of a method for providing access to associated data related to primary video data according to a preferred embodiment of the invention;

FIG. 4 depicts a flow diagram of a method for providing access to associated data related to primary video data according to an alternative embodiment of the invention;

FIG. 5A depicts a functional block diagram of an apparatus for providing access to associated data related to primary media data according to a preferred embodiment of the invention;

FIG. 5B depicts a functional block diagram of an apparatus for providing access to associated data related to primary media data according to an alternative embodiment of the invention;

FIG. 6 depicts a functional block diagram of an apparatus for providing access to associated data related to primary video data according to a first embodiment of the invention;

FIG. 7 depicts a functional block diagram providing further details of the apparatus of FIG. 6;

FIG. 8 depicts an example of associated data embedded in a primary media data stream;

FIG. 9 depicts a functional block diagram providing further details of the apparatus of FIG. 6;

FIG. 10A depicts an example of a primary video media presentation which includes a link to supplemental information according to a preferred embodiment of the invention;

FIG. 10B depicts an example of supplemental information in the form of a webpage displayed on a display device according to a preferred embodiment of the invention;

FIG. 11 depicts a functional block diagram of an apparatus for providing access to associated data related to primary media data according to a second embodiment of the invention;

FIG. 12 depicts a flow diagram of a method for providing access to associated data related to primary media data according to another embodiment of the invention;

FIG. 13 depicts a functional block diagram of an apparatus for providing access to associated data related to primary media data according to a third embodiment of the invention;

FIG. 14 depicts a functional block diagram of an apparatus for providing access to associated data related to primary media data according to a fourth embodiment of the invention;

FIG. 15 depicts a flow diagram of a method for providing access to associated data related to primary media data according to yet another preferred embodiment of the invention;

FIG. 16 depicts a third-party application server and database according to an embodiment of the invention; and

FIGS. 17-20 depict a flow diagrams of methods for sending an email to provide access to supplemental data related to primary media data according to embodiments of the invention.

### DETAILED DESCRIPTION

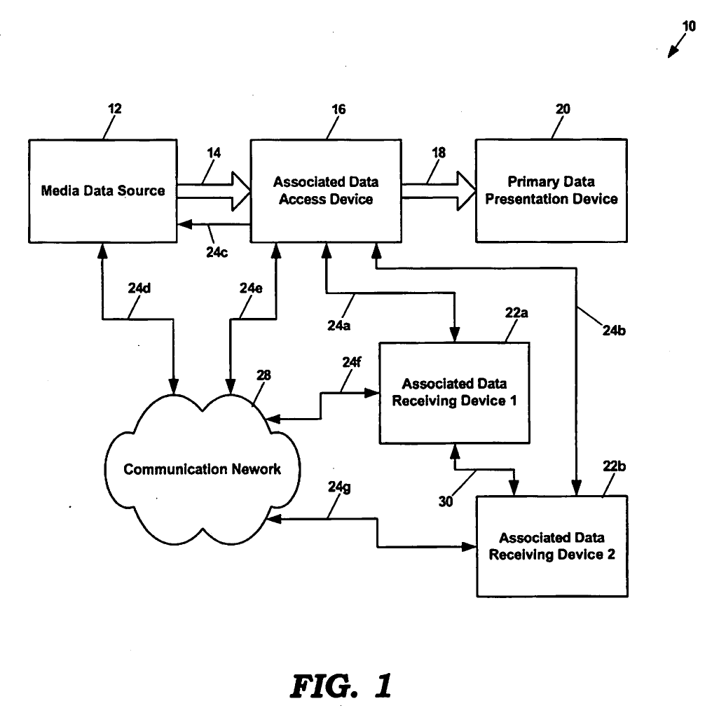

FIG. 1 depicts a preferred embodiment of a system 10 for providing access to associated data that is related to primary media data. For the purpose of this description, “primary media data” is information that provides or conveys media content. For example, primary media data includes but is not limited to video data, audio data, graphics data and/or textual data conveyed by any means. For the purpose of this description, “associated data” is information in any form that leads to or points to a source of additional information that is in some way related to the primary media data. For example, associated data may include but is not limited to a link to a webpage, a network address, a computer application, a computer file, an email message, a text message, a voice message or a data string.

Video data includes television data such as may be conveyed by satellite, cable or wireless terrestrial signals, video information stored on a storage medium such as a digital versatile disk (DVD) or other optical disk or magnetic hard drive, video information conveyed via a communication network such as the Internet, video information displayed on a large-format video display screen such as a Sony JumboTron™ screen, and video information projected in a movie theater. Video data may be encoded in any one of a number of formats, such as MPEG-4, Sorenson 3, Theora and Windows Media Video.

Audio data includes radio data such as may be conveyed by satellite, cable or wireless terrestrial signals, audio information stored on a storage medium such as compact disk (CD) or other optical disk or magnetic hard drive, audio information presented at a live media event such as a concert or sporting event, audio information in a cinematic movie soundtrack, and audio information conveyed via a communication network such as the Internet. Audio data may be encoded in any one of a number of formats, such as MP3, Dolby Digital, DTS and Windows Media Audio.

As shown in FIG. 1, the system 10 includes a media data source 12 which provides or conveys the primary media data. In preferred embodiments, the media data source 12 is a satellite television service provider, cable television service provider, terrestrial television broadcaster, satellite radio service provider, cable radio service provider, terrestrial radio broadcaster, the Internet, a digital media player of a personal computer, a DVD player, CD player, MP3 player, digital tape player, a computer hard drive, an optical disk drive or cinematic movie soundtrack. It should be appreciated that the media data source 12 of the present invention is not limited to the above-listed devices or sources. The media data source 12 generates or conveys a media data stream which is represented by the arrow 14. In preferred embodiments, the media data stream 14 carries the primary media data and the associated data together. In alternative embodiments, some or all of the associated data is conveyed via a channel or path which is separate from the media data stream 14.

With continued reference to FIG. 1, the system 10 includes an associated data access device 16 which receives the media data stream 14 provided by the media data source 12. In preferred embodiments of the invention, the associated data access device 16 accesses the associated data which is present in the media data stream 14 or in an associated channel. As described in more detail below in connection with certain embodiments, the associated data access device 16 detects the presence of associated data, extracts or copies the associated data from the media data stream 14 or other channel, decodes the associated data (if necessary) and writes the associated data to memory in the associated data access device 16. In various embodiments, the associated data access device 16 is a component of a satellite television receiver, terrestrial television receiver or cable television receiver (any of which may also be referred to herein as a “set top box” (STB)), a component of a television receiver card of a personal computer, a component of a digital video recorder, a component of a satellite radio receiver, terrestrial radio receiver or cable radio receiver, a component of a wireless mobile communication device, such as a cellular phone or PDA, or a component of a DVD player, CD player or other digital media player.

In preferred embodiments of the invention, the associated data access device 16 decodes and processes the primary media data in the media data stream 14 to generate a media information signal 18. The media information signal 18 carries the primary media program in the form of video and/or audio information content to a primary data presentation device 20 which presents the primary media program to a media recipient. In alternative embodiments, the associated data access device 16 passes the primary media data through unaltered after accessing the associated data. In these embodiments, the primary data presentation device 20 decodes and processes the primary media data.

The associated data access device 16 provides the associated data via a data link 24a to an associated data receiving device 22a. Some embodiments of the invention include more than one associated data receiving device and data link thereto, such as the additional device 22b and data link 24b depicted in FIG. 1. In preferred embodiments of the invention, the associated data receiving devices 22a and 22b each comprise a personal computer, a laptop computer, a server computer, a personal digital assistant (PDA), a cellular phone or other wireless communication device, or a component of any of these devices. Generally, functions of the associated data receiving devices 22a and 22b include receiving the associated data from the associated data access device 16, accessing supplemental information at one or more locations indicated by the associated data and presenting the supplemental information to a media recipient.

For purposes of this description, “supplemental information” is information in any form to which the associated data points or leads that is in some way related to the primary media data. For example, supplemental information may include but is not limited to a webpage, a computer application, an email message, a video data file, an audio data file, a text data file, a text message, a voice message or an image data file. Various examples of supplemental information are described in more detail below.

In the embodiment of FIG. 1, the media data source 12, the associated data access device 16 and the associated data receiving devices 22a and 22b are in communication with a wide area communication network 28, such as the Internet.

In some embodiments, the associated data access device 16 can communicate with the associated data receiving device 22a via an indirect communication link that consists of (1) a network connection 24c between the associated data access device 16 and the media data source 12, (2) a network connection 24d between the media data source 12 and the communication network 28 and (3) a network connection 24f between the communication network 28 and the associated data receiving device 22a. In a preferred embodiment, the network connection 24c is provided on the same communication conduit as the primary media data 14. For example, if the media data source 12 is a cable television provider, the connection 24c and the cable television data 14 may be provided via the same physical coaxial cable or optical fiber.

In some embodiments, the associated data access device 16 can additionally or alternatively communicate with the associated data receiving device 22a via an indirect communication link that consists of (1) a network connection 24e between the associated data access device 16 and the communication network 28 and (2) the network connection 24f between the communication network 28 and the associated data receiving device 22a.

Similarly, various alternative connection options exist between the associated data access device 16 and the associated data receiving device 22b which incorporate the network connection 24g.

In some preferred embodiments of the invention, the links 24a-24g are wireless data links, such as WiFi links (IEEE 802.11), Bluetooth links (IEEE 802.15.1), cellular links (such as Global System for Mobile communications (GSM)) or an infrared serial links. In other preferred embodiments, the links 24a-24g are wired links, such as via a Universal Serial Bus (USB), a Peripheral Component Interconnect (PCI) bus, a local area network (LAN), or a wide area network (WAN) such as the Internet.

In some preferred embodiments, the associated data receiving device 22a simply stores the associated data in memory and passes it along to another associated data receiving device 22b via a direct data link 30 or via the communication links 24f and 24g and the communication network 28. The second associated data receiving device 22b may perform any or all of the functions of the first associated data receiving device 22a described above, and in preferred embodiments it comprises a personal computer, a laptop computer, a server computer, a personal digital assistant (PDA), a cellular phone or other wireless communication device, or a component of any of these devices. The direct data link 30 may be a wireless data link, such as a WiFi link, a Bluetooth link, a cellular link or an infrared serial link. Alternatively, the direct link 30 may be a wired connection, such as via a USB link, a PCI bus, a LAN link or a WAN link.

As shown in FIG. 1, the primary data presentation device 20 receives the primary media information 18 from the associated data access device 16. In preferred embodiments wherein the associated data access device 16 decodes and processes the primary media data, the primary data presentation device 20 comprises a television display device, an audio receiver/amplifier and speaker system, an LCD screen of a computer, PDA or cellular phone, a cinematic movie projector, a digital projector or a large-format video display device. In embodiments wherein the associated data access device 16 passes through the primary media data, the primary data presentation device 20 includes the decoding and processing components needed to provide the primary media information in a format which is compatible as input to a television display device, an audio receiver/amplifier and speaker system, an LCD display screen, a cinematic movie projector, a digital projector or a large-format video display device.

In some embodiments of the invention, the associated data access device 16, the associated data receiving device 22a, and the primary data presentation device 20 are components of a single media presentation device, such as a personal computer, a laptop computer, PDA or cellular phone. Such embodiments are described in more detail below.

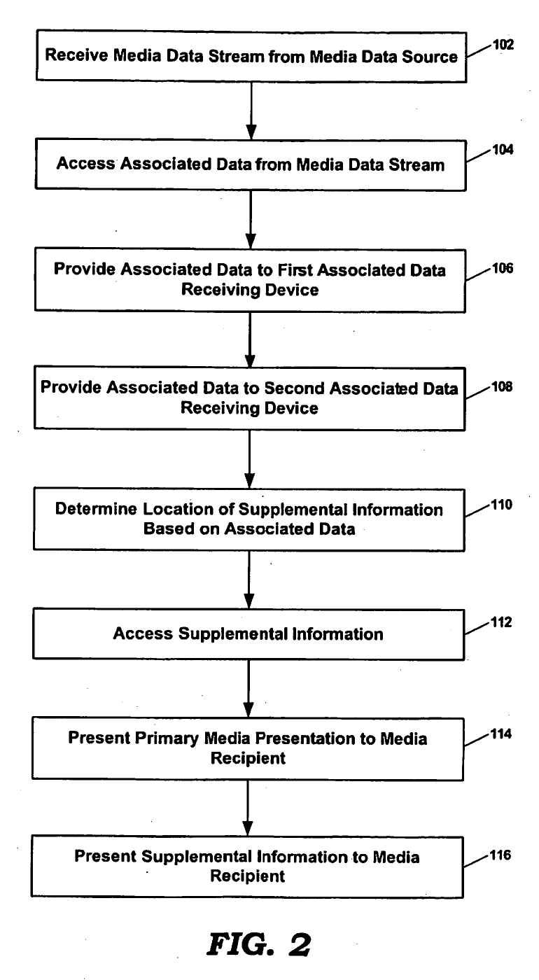

FIG. 2 depicts a method for transferring media information from a media data source to a media recipient using the embodiment of the invention depicted in FIG. 1. This method includes receiving a media data stream 14 containing television, movie, radio, music or live event data from the media data source 12 (step 102). Associated data within the media data stream 14 is accessed using an associated data access device 16 (step 104), and the associated data is provided to a first associated data receiving device 22a (step 106). In some embodiments of the invention, the associated data may also be provided to a second associated data receiving device 22b (step 108), such as by transferring the associated data from the first associated data access device 22a via the data link 30. Based on the associated data, a location, such as a network address, of supplemental information is determined (step 110). The supplemental information is then accessed, such as by the first associated data receiving device 22a or the second associated data receiving device 22b (step 112), and the supplemental information is presented to the media recipient (step 116.) At some point during the process, the primary media content, such as the television, movie, radio, music or live event content, is also presented to the media recipient via the primary data presentation device 20 (step 114).

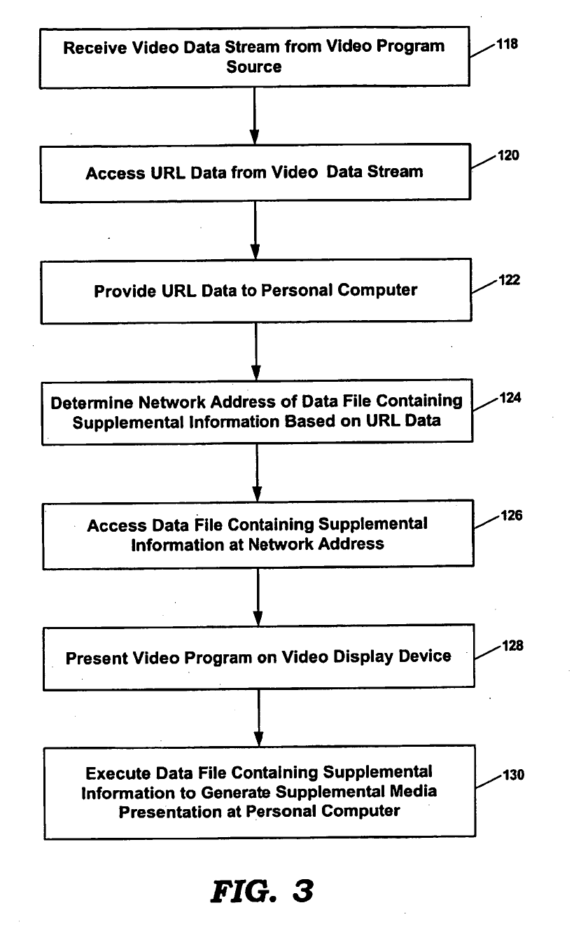

One embodiment of the method of FIG. 2 is depicted in FIG. 3. In this embodiment, the method includes receiving a video data stream 14, such as an MPEG-2 or MPEG-4 video stream, from a video data source 12, such as a satellite or cable television provider, a DVD player, a digital tape player or a computer media player (step 118). A Uniform Resource Locator (URL) embedded in the video data stream 14 is accessed using the associated data access device 16 (step 102) and the URL is provided to a personal computer 22a (step 122). Based on the URL, a network address of a supplemental information data file is determined (step 124). The supplemental information data file, such as a Hypertext Markup Language (HTML) file, video file or audio file, is then accessed at the indicated address (step 126) and is provided to the personal computer 22a where the supplemental information is presented to the media recipient (step 130). At some point during the process, the primary media content, such as the television program, movie or other video program, is also presented to the media recipient using a video display device 20 (step 128).

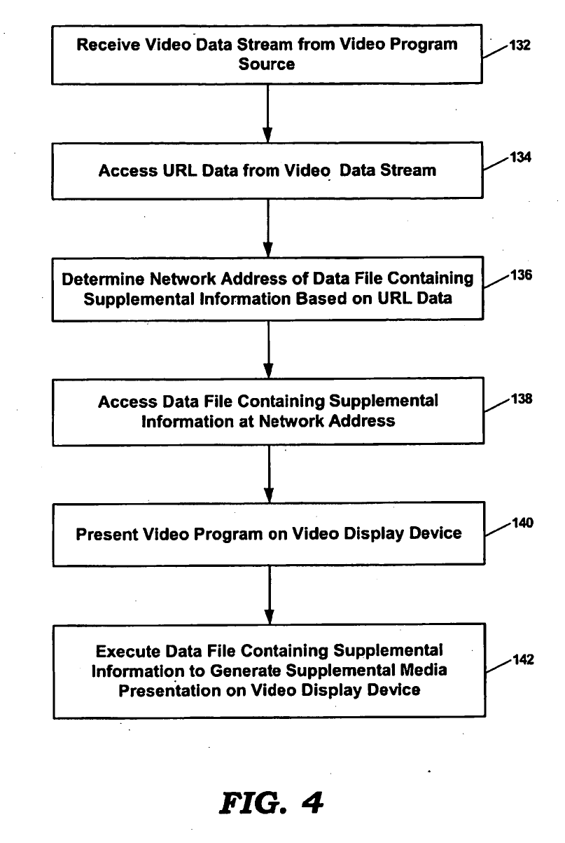

Another embodiment of the method of FIG. 2 is depicted in FIG. 4. In this embodiment, the method includes receiving a video data stream 14, such as an MPEG-2 or MPEG-4 video stream, from a video data source 12, such as a satellite or cable television provider, a DVD player or a computer media player (step 132). As in the embodiment of FIG. 3, a URL embedded in the video data stream 14 is accessed using the associated data access device 16 (step 134). However, in the embodiment of FIG. 4, the URL is not provided to a personal computer. Rather, the URL is processed by the associated data access device 16 to determine a network address of a supplemental information data file (step 136). The supplemental information data file, such as an HTML file or video file, is then accessed at the indicated address (step 138) and is presented to the media recipient on the video display device 20 (step 142). At some point during the process, the primary video content is also presented to the media recipient on the same video display device 20 (step 140).

The method of FIG. 4 encompasses an embodiment wherein the primary media data, such as a video clip or music clip, is received by a cellular phone or wireless PDA device, circuitry within the phone or PDA accesses a URL encoded in the video or music clip, and the phone or PDA uses the URL to access a webpage related to the video or music clip. The method of FIG. 4 also encompasses an embodiment wherein the primary media data is a media data file played using a media player application on a personal computer, an application running on the computer accesses a URL encoded in the media data file, and the computer uses the URL to access a webpage related to the content of the media data file.

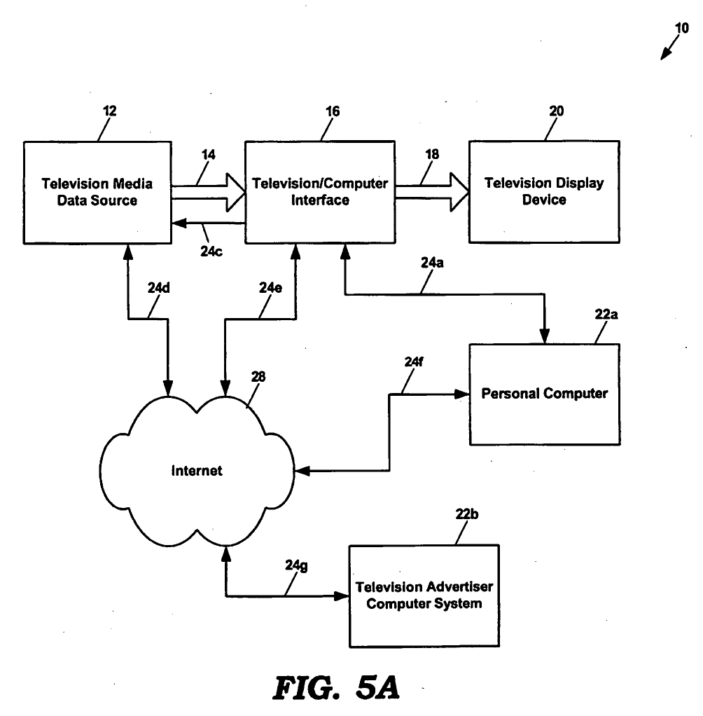

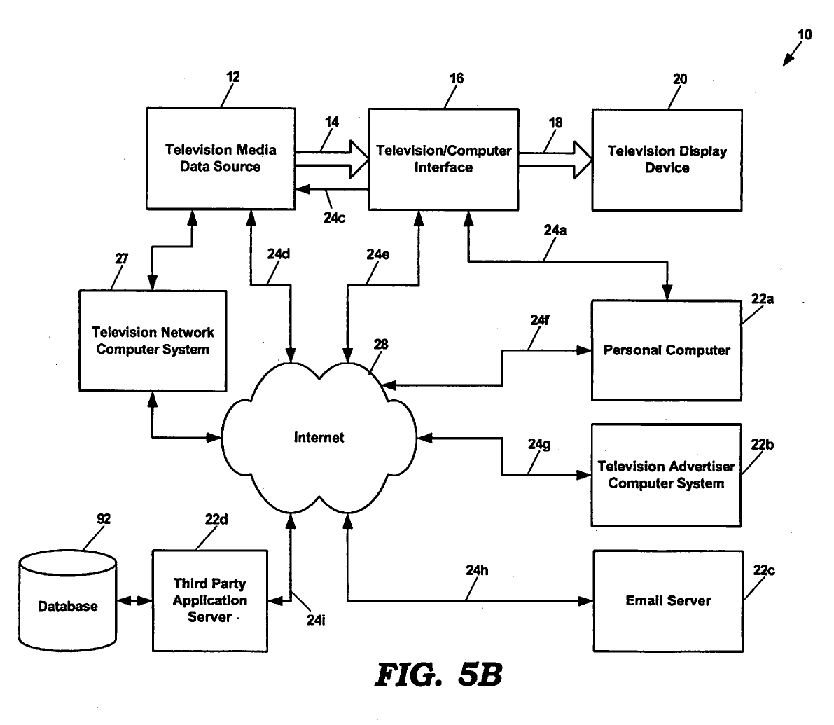

FIG. 5A depicts a preferred embodiment of the invention wherein the primary media content is television programming. In this embodiment, the media data source 12 is a television media data provider 12, such as a cable or satellite television service provider. The associated data access device 16 of this embodiment comprises a television/computer interface 16, the associated data receiving device comprises a personal computer 22a, and the primary data presentation device comprises a television display device 20.

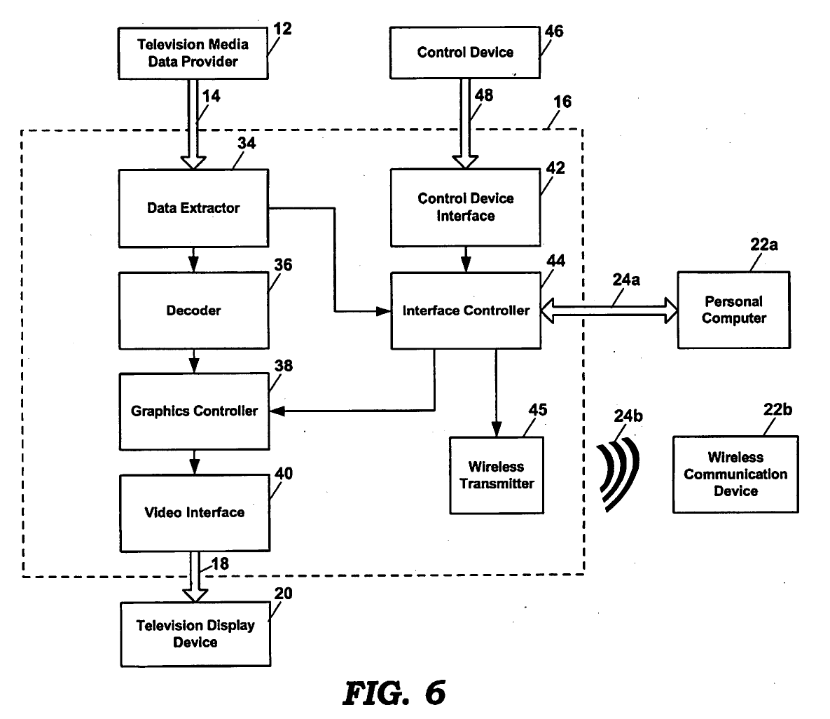

FIG. 6 depicts components of the television/computer interface 16 which may be contained in a set-top box according to a preferred embodiment of the invention. The television/computer interface 16 includes a data extractor 34 that receives the digital media stream 14 from the television media data source 12. The purpose of the data extractor 34 of this embodiment is to extract or copy the associated data from the media data stream 14 and provide it to the computer 22a.

Associated data may be present in the digital media stream 14 for various purposes, such as to identify the source of the primary television program or the particular type of software that was used to produce or encode the video data. As alluded to previously, associated data may also be used to provide information to consumers regarding products or services depicted in the primary television program.

The associated data may be embedded in a “user data” section of the digital media stream 14. As described in more detail below, the data extractor 34 monitors the encoded digital media stream 14 and “listens” for the beginning of a user data section. When a user data section is detected, the data extractor 34 copies the associated data from the encoded data stream 14 and passes it to an interface controller 44. The interface controller 44 sends the copied data from the data extractor 34 to the computer 22a over the link 24a. In some embodiments, the interface controller 44 extracts graphical data from the associated data and sends it to the graphics controller 38. Although the associated data is copied from the digital media stream 14 as it passes through the data extractor 34, the digital media stream 14 that enters the television/computer interface 16 preferably passes through the data extractor 34 substantially unaltered.

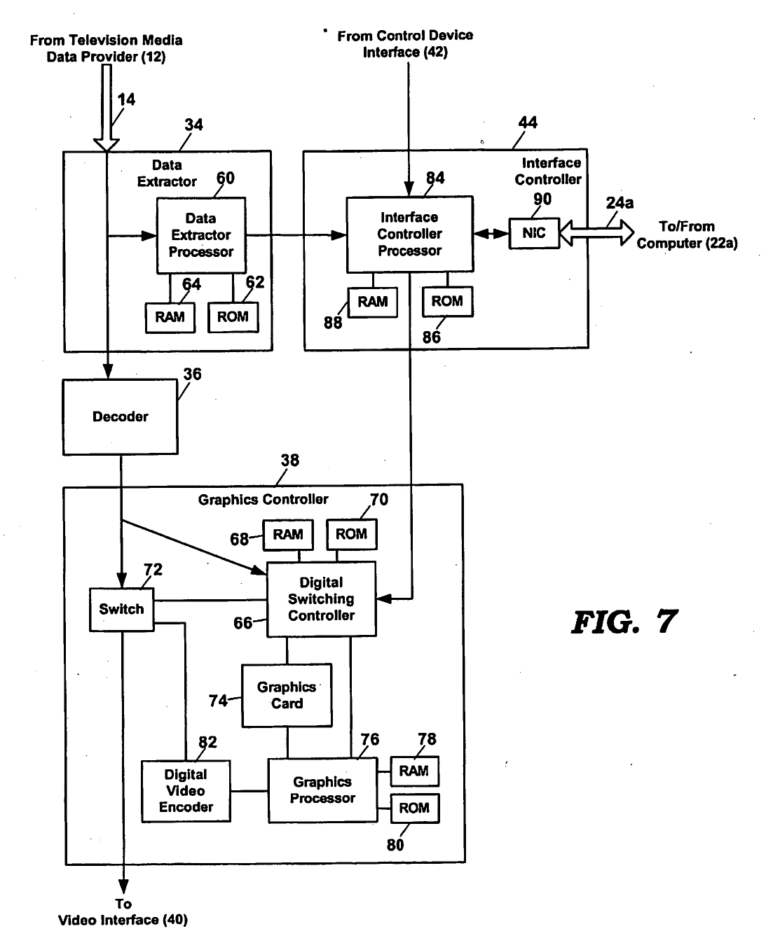

In preferred embodiments of the invention, the data extractor 34 functions as a listening port patched onto the digital media data stream 14. As shown in FIG. 7, the data extractor 34 includes a data extractor processor 60 that monitors the data stream 14 for sequences of the associated data in the digital media signal. The data extractor 34 also includes read-only memory (ROM) 62 for storing programming instructions and random access memory (RAM) 64 for temporary storage of data.

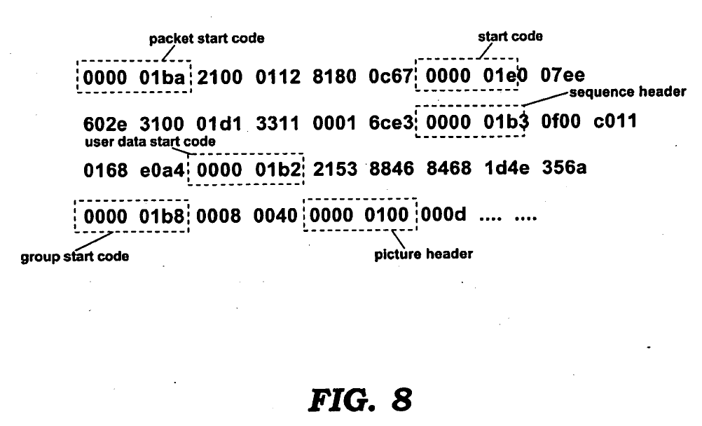

To provide background for describing the operation of the data extractor 34, the data format of an MPEG-2 data stream is first described with reference to FIG. 8, which represents typical MPEG-2 data in hexadecimal format. As shown in FIG. 8, an MPEG-2 data stream may include a number of different “start codes” that indicate the beginning of various portions of the data stream. According to the MPEG-2 standard for digital video as set forth in ISO/IEC 13818-2, start codes are specific bit patterns that do not otherwise occur in the video stream. Each start code consists of a start code prefix followed by a start code value.

According to the MPEG-2 standard, the start code prefix is a string of twenty three bits with the value of zero followed by a single bit with the value one. Thus, the start code prefix is the bit string “0000 0000 0000 0000 0000 0001” (0000 01 in hexadecimal). Immediately following the start code prefix is the start code value. The start code value is an eight bit integer that identifies the type of start code. Most types of start code have just one start code value.

The start code value for the “user data” portion of the MPEG-2 stream is “b2” in hexadecimal. Thus, as shown in FIG. 8, the hexadecimal value for the user data start code is “0000 01b2.” The user data comprises all the data in the data stream that follows the user data start code and precedes a stop code (or the next start code). The user data section can be of any length. In the example of FIG. 8, the user data comprises the string “2153 8846 8468 1d4e 356a.”

The SMPTE Registration Authority, LLC is currently authorized by the International Organization of Standardization (ISO) to register MPEG-2 format identifiers. The registration descriptor of MPEG-2 standard is provided by ISO 13818-1 to enable users of the MPEG-2 standard to unambiguously carry data when the format of the data is not necessarily a recognized international standard. This provision permits the MPEG-2 video transport standard to carry various types of data while providing for a method of unambiguous identification of the characteristics of underlying private data.

Entities that are registered with SMPTE are assigned a unique code that can be recognized in the video stream. Using this registration code, a registered entity can embed specific associated data in the user data section of the video data stream. The registration code can also be used to locate and extract the associated data.

With reference to FIG. 7, the data extractor processor 60 listens for the user data start code (0000 01B2) in the MPEG-2 data stream based on programming instructions stored in the ROM 62. Once the user data start code is detected, the processor 60 jumps to another section of programming in the ROM and begins listening for an appropriate registration code. When the registration code is detected, the processor 60 begins copying all the preceding data into the RAM 64 until a stop code is detected. The processor 60 forwards the data saved in the RAM 64 to the interface controller 44. The processor 60 then recycles and begins listening for the next user data start code.

After the video stream passes through the data extractor 34, a decoder 36, such as an MPEG-2 or MPEG-4 decoder, decodes the digital media stream into a pure digital luminance/chrominance (Y/C) signal. In some embodiments of the invention, the decoded media signal is provided to a graphics controller 38 which combines the media stream data with graphics data from the computer 22a, if it is instructed to do so. Finally, depending again on the application of the television/computer interface 16 and the type of television display device 20 in use, the digital media signal may be converted into one or more analog signals in a video interface 40. Thus, depending on the particular embodiment of the invention, the signal provided to the television display device 20 may be component video, composite video, Digital Visual Interface (DVI), High-Definition Multimedia Interface (HDMI) or other video or multimedia format.

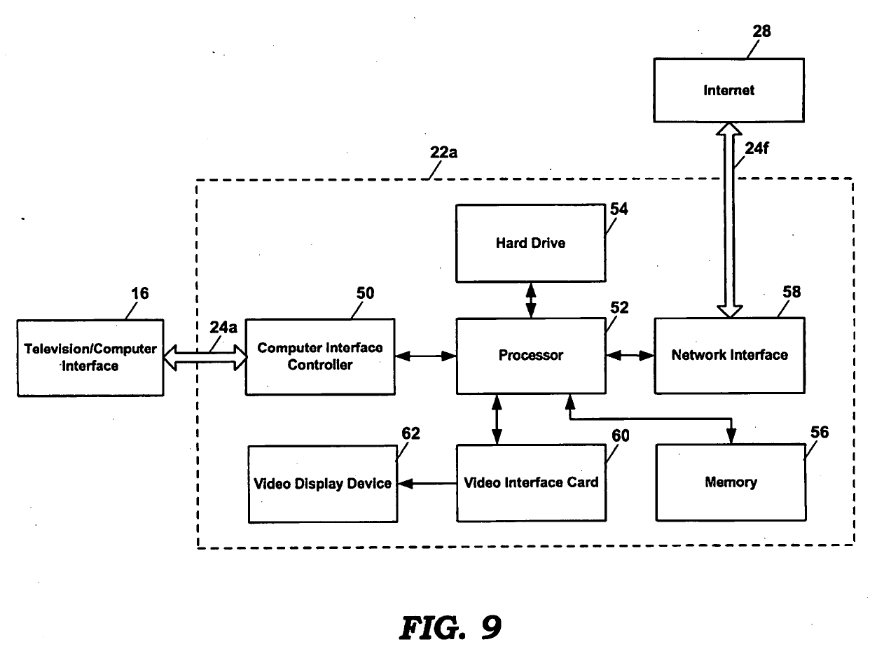

FIG. 9 depicts a preferred embodiment of the computer 22a, which comprises a computer interface controller 50, a processor 52, a hard drive 54, memory 56, a communication network interface 58, a video graphics card 60 and a display device 62. The interface controller 50 may be a local area network interface card, a USB controller or an address/data bus, such as a PCI bus. The interface controller 50 provides the data interface between the television/computer interface 16 and the processor 52.

Using the hard drive 54 and the memory 56, the processor 52 processes the associated data from the television/computer interface 16 depending on the type of associated data received. If the associated data is a link to a webpage accessible via the Internet, the processor 52 uses browser software to fetch the requested webpage via the network interface 58. In a preferred embodiment wherein the webpage graphics are to be displayed on the computer display device 62, the processor 52 generates webpage graphics instructional data based on the link data and provides the graphics instructional data to the computer's video card 60.

As shown in FIG. 7, the interface controller 44 includes an interface controller processor 84 that is in communication with to the control device interface 42, data extractor 34 and graphics controller 38. The control device interface 42 and the data extractor 34 provide data to the processor 84 which operates on the data based on instructions stored in the ROM 86. These instructions determine how the processor 84 is to modify the associated data so that it can be sent to the network interface card (NIC) 90 and on to the computer 22a in a format that can be understood by software running on the computer 22a. After the associated data is modified appropriately, it is stored to the RAM 88 until it is sent to the NIC 90.

In some preferred embodiments, the processor 84 of the interface controller 44 extracts a text string from the associated data and passes the text string to the graphics controller 38 to be inserted into the video displayed on the display device 20. The processor 84 is also responsible for passing the associated data on to the computer 22a via the network interface card 90 and the link 24a. In some embodiments, the interface controller 44 waits for instruction from the control device 46 before it passes the associated data on to the computer 22a. In other embodiments, the interface controller 44 automatically passes the associated data on to the computer 22a whenever the controller 44 receives the associated data from the data extractor 34.

Preferably, these operations work in substantially the same manner in reverse. When the NIC 90 receives data from the network link 24, it sends the data to the processor 84. The processor 84 then uses instructions from the ROM 86 to modify the data appropriately to send it on to the graphics controller 38. The modified data is then stored in the RAM 88 until the proper time to be forwarded to the graphics controller 38.

As shown in FIG. 7, the graphics controller 38 provides a system for generating graphics and embedding them synchronously into the digital media stream. In a preferred embodiment of the invention, the graphics controller 38 includes a digital switching controller 66 with associated RAM 68 and ROM 70, a data switch 72, graphics card 74, graphics processor 76 with associated RAM 78 and ROM 80, and a digital video encoder 82.

In one embodiment, the digital switching controller 66 receives its instructions from the interface controller 44 and divides those instructions into graphics instructions and embedding instructions. The digital switching controller 66 forwards the graphics instructions to the graphics card 74 and saves the embedding instructions in RAM 68. The digital switching controller 66 is also responsible for monitoring the digital media signal that passes through the data extractor 34, preferably in the same manner as the data extractor 34 monitors the digital media signal 14. The digital switching controller 66 monitors the digital media signal for the appropriate location in the data stream to activate the switch 72 to allow graphics to be embedded in the stream. This embedding location is determined based on the embedding instructions that were stored in RAM 68. In a normal mode, the switch 72 allows the digital media signal to pass unaltered. When the switch 72 receives appropriate instructions from the digital switching controller 66, the switch 72 is operated in a graphics insertion mode wherein graphics created in the graphics processor 76 are synchronously inserted into the video stream. In the preferred embodiment, this synchronous switching is accomplished using switching logic gates in the switch 72. An example of a similar switching scheme is that used in cable or satellite set-top boxes to insert programming guide graphics into a video signal along with an incoming video program signal.

In the preferred embodiment, the graphics card 74 operates in the same manner as graphics cards used in personal computers. The graphics card 74 receives the graphics instructions from the digital switching controller 66 in a format which is the same as, or very similar to, the format such instructions would be provided by a personal computer.

Based on the graphics instructions from the digital switching controller 66, the graphics card 74 outputs the graphics data that the graphics processor 76 copied to its RAM 78. The graphics processor 76 then waits for a signal from the digital switching controller 66 that it is time to embed the graphics data into the digital media signal. When the digital switching controller 66 tells the graphics processor it is time to embed the graphics data, it either tells the graphics processor 76 how much data it is going to embed or it tells the graphics processor 76 when to stop. When the graphics processor 76 is instructed to embed the graphics data, it outputs the data to the digital video encoder 82 which converts the data to the appropriate video format. For example, if the graphics card 74 created the graphics data in RGB format, the digital video encoder 82 converts the data into digital video luminance/chrominance (Y/C) format. The digital video encoder 82 then outputs the data to the switch 72 which embeds the graphics data into the digital media signal.

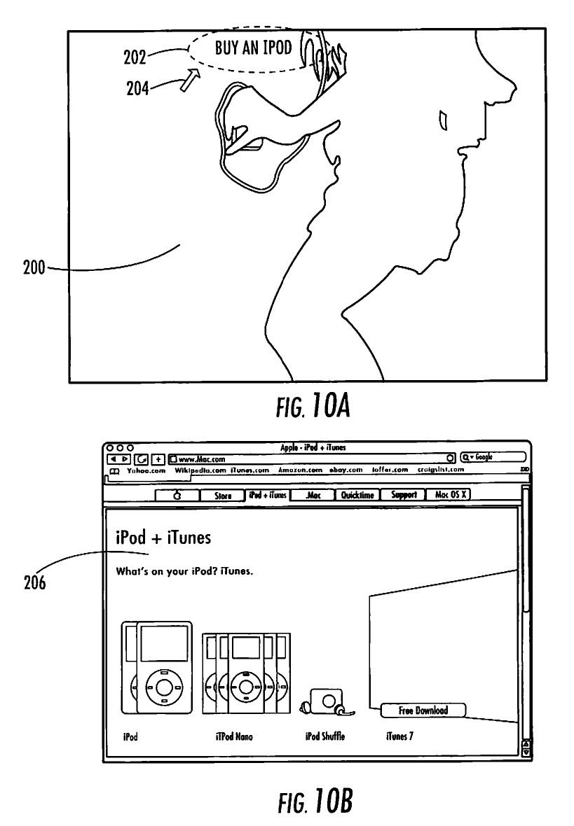

FIG. 10A depicts an example of television screen graphics generated by the embodiment of FIG. 6. While receiving a video data stream depicting a television advertisement 200 for an Apple IPod, the data extractor 34 detects and copies associated data in the video data stream that includes the textual phrase “Buy an iPod.” Based on this associated data, the graphics controller 38 generates a graphical representation of the same textual phrase and embeds it in the digital media signal as described previously. As a result, the graphical representation 202 of “Buy an iPod” appears on the television display 20 along with the primary video information for the television advertisement 200.

In this example, the associated data detected by the data extractor 34 also includes link information pointing to a webpage where a consumer may obtain further information and/or purchase an iPod. In this example, the associated data may be provided as a URL or an IP address. In a preferred embodiment, the associated data is automatically copied and sent to the interface controller 44 which provides the data to the computer 22a by way of the link 24a.

As shown in FIG. 6, the associated data may alternatively or additionally be transmitted wirelessly via a transmitter 45, such as a Bluetooth transmitter, to a wireless communication device 22b which is in communication range of the transmitter 45. The wireless communication device 22b, such as a cellular phone, PDA or laptop computer, may then be used to access the supplemental information to which the associated data points.

With reference again to FIG. 10A, when a user sees the text graphics 202 appear, this indicates to the user that supplemental information regarding the advertised product is available. To access that supplemental information, the user presses a button on a remote control device 46 (FIG. 6) to activate the interface controller 44 to send a request signal to the computer 22a. In response to the request signal, the computer 22a executes a browser application to access the webpage indicated by the URL. For example, the webpage may be stored on a server computer of a television advertiser computer system 22b. (FIG. 5A.) As shown in FIG. 10B, the webpage 206 is then displayed on the display device 62 (FIG. 9) of the computer 22a. In an alternative embodiment, the user may use a mouse, touch pad or remote control, to position a curser 204 to click on the text graphics 202 (FIG. 10A) which activates the interface controller 44 to send the request signal to the computer 22a.

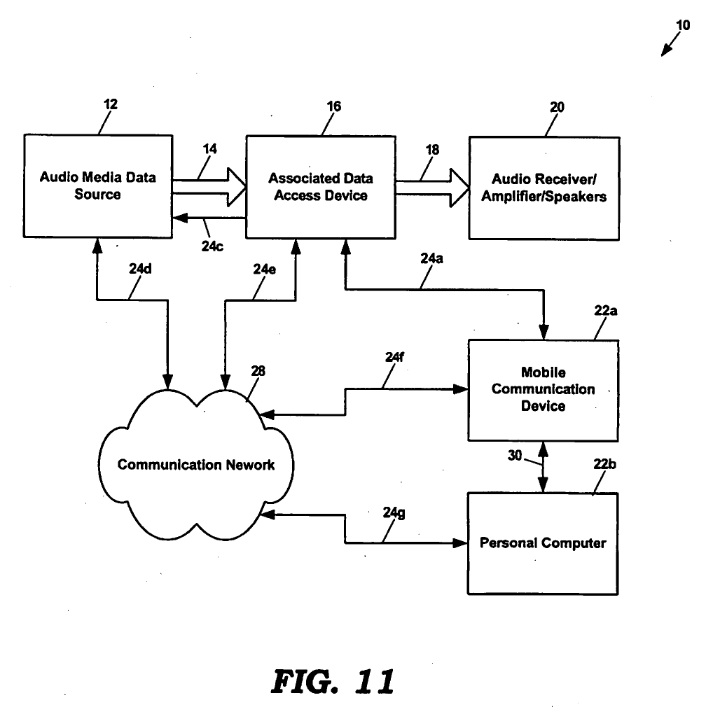

FIG. 11 depicts a preferred embodiment of the invention wherein the primary media content is audio programming, such as from a digital music file or a digital radio stream. In this embodiment, the media data source 12 is an audio media data source 12, such as a satellite radio service provider, a digital music file transferred via a network or a digital music file accessed from a CD or hard drive. The associated data access device 16 of this embodiment may be a component of a satellite radio receiver, a card in a personal computer, or a component of a CD player, MP3 player or other digital music player. The primary data presentation device 20 of this embodiment comprises an audio receiver/amplifier and associated audio reproduction devices, such as speakers or headphones. In the exemplary embodiment of FIG. 11, a first associated data receiving device 22a comprises a wireless mobile communication device, such as a cellular phone, PDA or laptop computer, which is in wireless communication with the associated data access device 16 via a wireless link 24, such as a WiFi, cellular, Bluetooth or infrared link. The embodiment of FIG. 11 may also include a second associated data receiving device 22b, such as a personal computer, which is in communication with the wireless mobile communication device 22a via the direct link 30 or via the communication network 28.

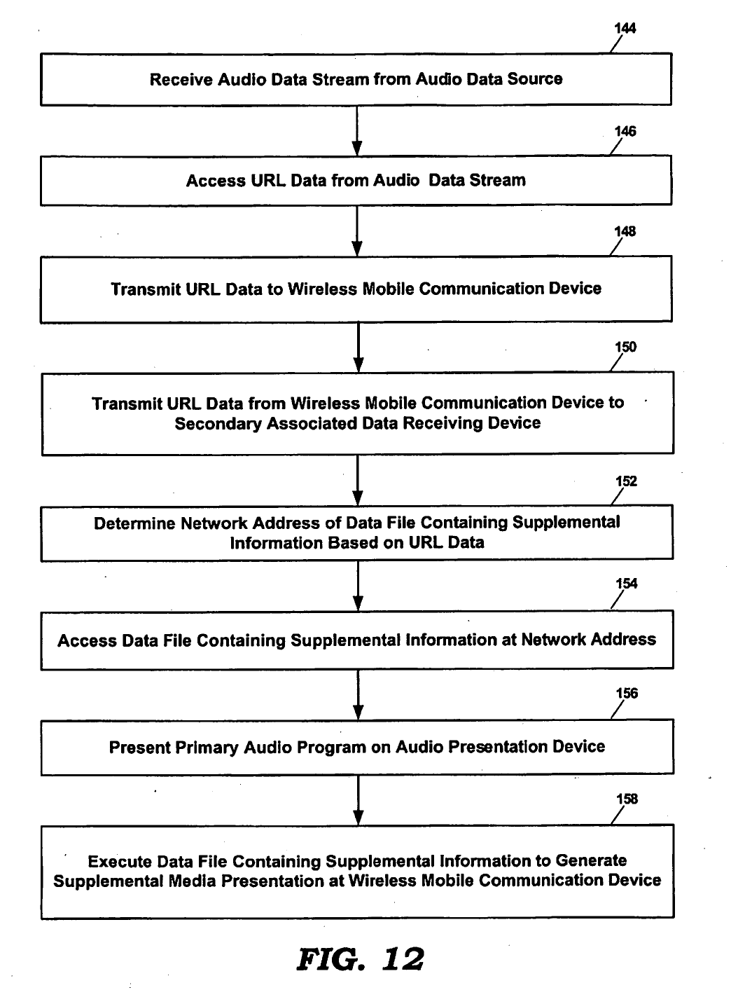

FIG. 12 depicts a method for transferring audio media information from an audio data source to a media recipient using the embodiment of the invention depicted in FIG. 11. In this embodiment, the method includes receiving audio data 14, such as an MPEG or MP3 audio stream, from the audio data source 12 (step 144). A URL embedded in the audio data 14 is accessed using the associated data access device 16 (step 146), and the URL is transmitted to the wireless mobile communication device 22a (step 148). Based on the URL, a network address of a supplemental information data file is determined (step 152). The supplemental information data file, such as a webpage, a video file or another audio file, is then accessed at the indicated address (step 154) and is provided to wireless mobile communication device 22a where the supplemental information is presented to the media recipient (step 158) or stored in memory for later access. At some point during the process, the primary audio content, such as the radio program, podcast, music or other audio program, is also presented to the media recipient via the audio receiver/amplifier and speakers 20 (step 156). Also at some point during the process, the URL data may be transferred from the wireless mobile communication device 22a to the personal computer 22b via the communication link 30 or the network 28 (step 150).

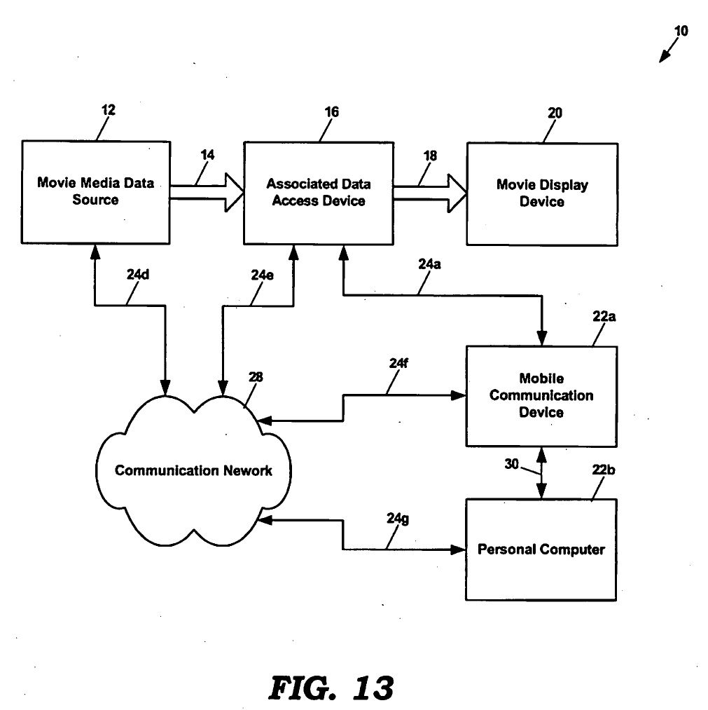

FIG. 13 depicts a preferred embodiment of the invention wherein the primary media content is an audio soundtrack from a cinematic motion picture presentation. In this embodiment, the media data source 12 is an audio media data source 12, such as a digital audio file accessed from a movie soundtrack or other magnetic or optical storage medium. The associated data access device 16 of this embodiment may be a component of a motion picture soundtrack processing device, such as a Dolby Digital processor or a Digital Theater System (DTS) processor. The primary data presentation device 20 of this embodiment comprises an audio receiver/amplifier and associated audio reproduction devices, such as speakers in a movie theater. In the exemplary embodiment of FIG. 13, a first associated data receiving device 22a comprises a wireless mobile communication device, such as a cellular phone, PDA or laptop computer, which is in wireless communication with the associated data access device 16 via a wireless link 24a, such as a WiFi, cellular, Bluetooth or infrared link. The embodiment of FIG. 13 may also include a second associated data receiving device 22b, such as a personal computer, which is in communication with the wireless mobile communication device 22a via the link 30 or the network 28.

The method depicted in FIG. 12 is also representative of a method for transferring primary movie soundtrack audio data and associated data using the embodiment of the invention depicted in FIG. 13. In this embodiment, the method includes receiving audio data 14, such as the Dolby Digital or DTS audio data, from the movie soundtrack 12 (step 144). A URL embedded in the audio data 14 is accessed using the associated data access device 16 (step 146), and the URL is transmitted to the wireless mobile communication device 22a (step 148). Based on the URL, a network address of a supplemental information data file is determined (step 152). The supplemental information data file, such as a webpage, a video file or another audio file, is then accessed at the indicated address (step 154) and is provided to wireless mobile communication device 22a where the supplemental information is presented to the media recipient (step 158) or stored in memory for later access. Contemporaneously with the associated data processing, the movie soundtrack is also presented to the media recipient via the audio receiver/amplifier and speakers 20 in the movie theater (step 156). Also at some point during the process, the URL data may be transmitted from the wireless mobile communication device 22a to the personal computer 22b via the communication link 30 or the network 28 (step 150). This part of the process may occur after the movie-goer has returned home and downloads the associated data from the wireless device 22a to the computer 22b.

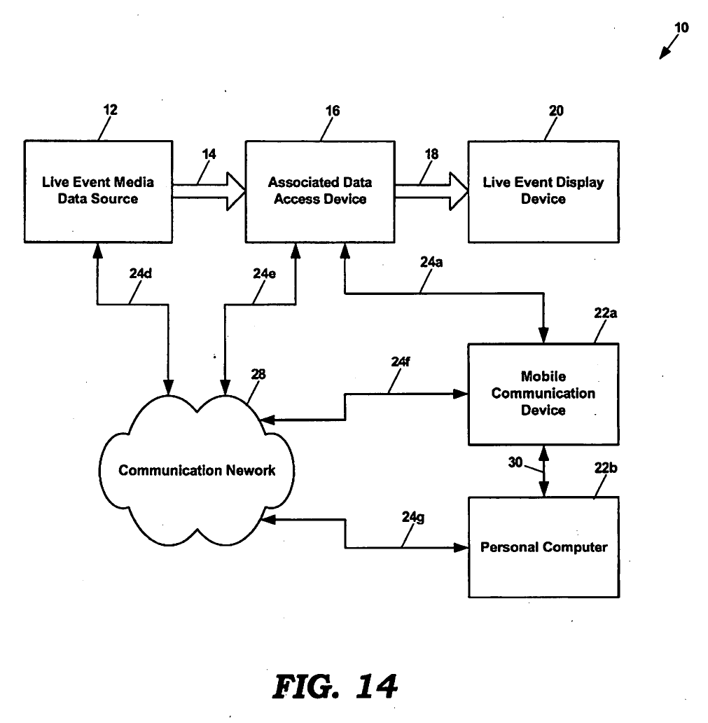

FIG. 14 depicts a preferred embodiment of the invention wherein the primary media content is video programming for a large-format video display. The display screen 20 of this embodiment may be a Sony JumboTron™ screen, such as is used in many sporting arenas, stadiums and public gathering places like Times Square in New York City. The display screen 20 of this embodiment also encompasses display screens used in other public places, such as shopping malls, retail stores, restaurants, sports bars and the like. The video data format for this embodiment may be any of the video formats described previously. Thus, the live event media data source 12 may comprise a computer hard drive, a DVD disk, a digital video tape or any other digital video source. Preferably, the associated data access device 16 of this embodiment functions in much the same way as the device 16 described above in reference to FIG. 6. In this embodiment, however, the preferred communication link 24 is wireless and the preferred associated data receiving device 22a is a mobile communication device, such as a Bluetooth-enabled cellular phone or PDA.

The embodiment of the invention depicted in FIG. 14 may be used during live events, such as sporting events or concerts. At such events, commercial or other informational presentations may be shown on a large-format video display 20 that is viewable within the event venue. While these presentations are being shown, associated data extracted from the primary video data stream 14 is transmitted via a wireless transmitter 45 in or near the event venue (see FIG. 6) to portable wireless devices 22a carried by spectators within the venue. For example, during a college football game, a video presentation promoting the home team may be shown on the display 20. During the presentation, associated data is transmitted within the venue which directs the spectators to supplemental information regarding the home team or the university. Another video presentation shown during the game may advertise a nearby restaurant, and the associated data may be directions to the restaurant and a special code for a discount on a food or beverage item.

The associated data may be a text message directed to each and every cellular phone in the venue, where the text message includes a special code the spectators may use to access information that is only available to those having the code. For example, the associated data may be a URL pointing to a webpage that is not otherwise accessible. In a preferred embodiment, the transmission from the transmitter 45 is a Bluetooth transmission which may be received only by Bluetooth-enabled phones, PDAs or other devices in the venue or the immediate vicinity. As with other embodiments described herein, the associated data may be transmitted from the wireless mobile communication device 22a to a personal computer 22b via a communication link 30 or the network 28. This transmission may occur after the event spectator has returned home and downloaded the associated data from the wireless device 22a to the computer 22b.

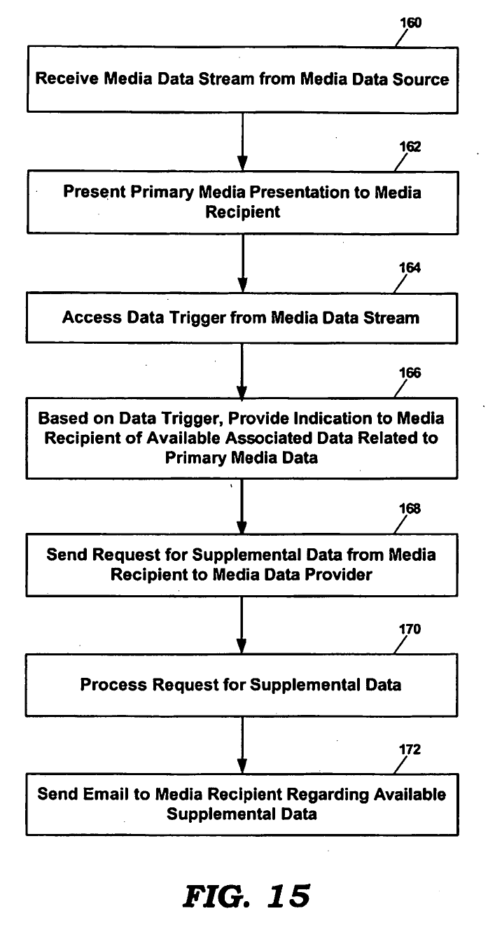

FIG. 15 depicts a method for providing access to associated data related to primary media data according to yet another embodiment of the invention. Although this method may be performed by several of the embodiments of the invention described herein, the following description is directed to the embodiment of FIG. 5B. An associated data access device, such as the television/computer interface 16, receives a television media data stream 14 from a television media data source (step 160). The television/computer interface 16 provides the primary television programming content 18 to a television display device 20 on which the programming is presented to a media recipient (step 162). The television/computer interface 16 extracts or copies a “trigger” data string from the television data stream (step 164). In a preferred embodiment, this trigger string is contained in the “user data” section of an MPEG stream as described above.

Based on the presence of the trigger string, the television/computer interface 16 generates a graphic icon, text, or window which is displayed on the television display device 20 and/or on a display device associated with the computer 22a (step 166). This icon or window provides an indication to the media recipient that supplemental information is available. When the media recipient clicks on the icon using the control device 46 (FIG. 6) or a mouse connected to the computer 22a, a request string is generated and transmitted from the television/computer interface 16 via the link 24e, the communication network 28 and the link 24g to a third-party computer system 22b, such as a computer system associated with an advertiser (step 168). The request string of step 168 could also be transmitted to the third-party computer system 22b by way of the links 24c and 24d, the communication network 28 and the link 24g. The request string initiates a request for supplemental data related to the television programming that included the trigger string. This request is processed by the computer system 22b and a response is sent from the computer system 22b to the media recipient (step 170). In a preferred embodiment, the response is in the form of an email message directed via the communication network 28 to an email server 22c associated with the media recipient's email address (step 172). The media recipient may then use the computer 22a to access the email message residing on the email server 22c via the network 28. In this embodiment, the email message includes supplemental information and/or associated data, such as a URL directing the media recipient to further supplemental information available at a website.

As shown in FIG. 5B, one embodiment of the invention includes a television network computer system 27 that may communicate with the personal computer 22a via the communication network 28. The personal computer 22a of this embodiment may download from the television network computer system 27 a special application for accessing associated data. When installed and running on the personal computer 22a, the special application uses trigger strings accessed from the television media stream 14 to provide links to supplemental information residing on the television network computer system 27. In this case, the supplemental information may include, for example, scheduling information related to the network's television shows. This embodiment illustrates a situation wherein the associated data and the supplemental data originate from a common source, i.e. the television network, but they are directed through two different communication channels; the primary media data through the television data source 12, such as a satellite or cable television provider, and the associated data from the television network computer system 27 via the communication network 28.

The embodiment of FIG. 5B, in essence, creates a bridge across the television and Internet platforms. It allows television viewers to jump from television directly to a specific site on the Internet. Using this embodiment, advertisers can create links to information on the web through TV commercials, infomercials and product placements. Also, this embodiment enables television networks to create a cross-platform experience by enhancing television shows and content with linked media and information on the Internet. Television networks can also use these links to receive input from viewers regarding what the viewers would like to see next or to receive votes in an interactive poll. For example, the embodiment of FIG. 5B could be used to allow the television audience to vote on what they would like to see happen next on a television program. For instance, the television program could have been filmed in numerous ways and the audience can vote for whether they want the show to go in direction A or direction B. Depending on the outcome of the vote, the television network can show clip A or B. This embodiment could also be used by viewers to request a reminder by email or text message to watch or record a program.

The email server 22c of this embodiment also allows for the invention to accumulate massive amounts of request data. For example, the server 22c could save and compile all link request activity on all television channels. This data could then be used to create detailed reports of many factors, such as how many viewers are or were watching, what they were watching, and how interested they were in the programming.

As shown in FIG. 5B, some embodiments of the invention include a third-party application server 22d connected to the communication network 28 via a communication link 24i. The server 22d is referred to herein as a “third-party” application server since it may be operated by a third-party entity, that is, an entity other than the media data source 12, the television network computer system 27 or the advertiser computer system 22b. For example, the third-party application server may be operated by an entity such as Nexnet Corporation of Knoxville, Tenn., whose main focus is providing access to supplemental data that is related to the primary media data. As described in more detail below, the third-party application server 22d is a computer system that, among other things, executes applications which determine content to be included in supplemental data that is sent to a media recipient. In preferred embodiments, the supplemental data content is determined based on a specification stored in a database 92 connected to the server 22d.

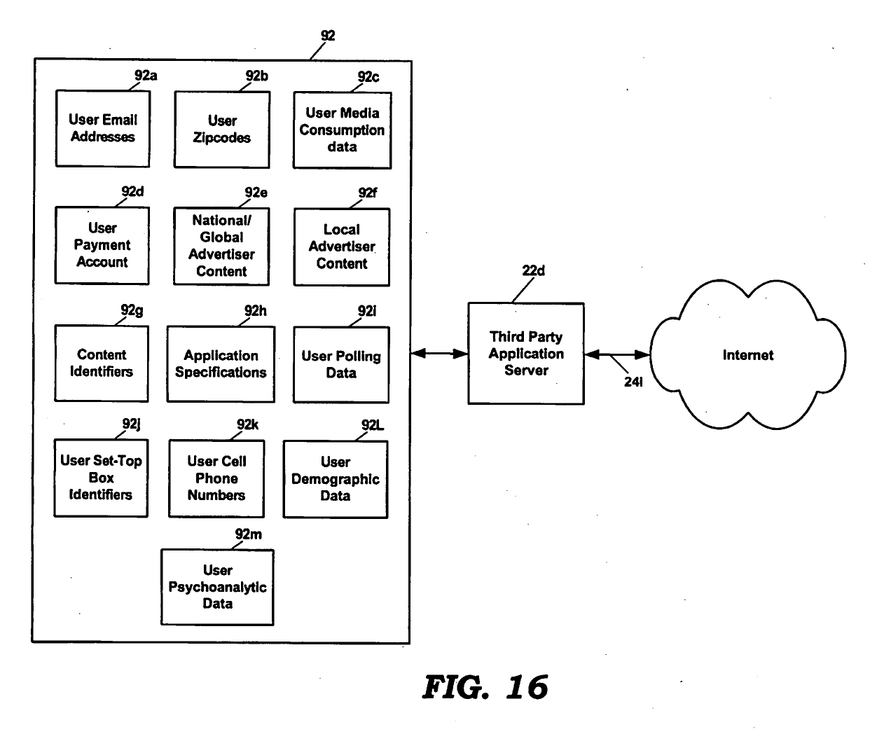

As shown in FIG. 5B and FIG. 16, the database 92 stores user email addresses 92a in association with user zip codes 92b. Each user email address and zip code is associated in the database 92 with an identification number for the user's television/computer interface unit 16, such as the serial number or MAC address of the user's cable television set-top box or satellite television receiver. The database also stores user media consumption data 92c and user payment account information 92d in association with the other user data. The database 92 also preferably stores national/global advertiser content 92e, local advertiser content 92f, content identifiers 92g, application specifications 92h, user polling data 92i, user cell phone numbers 92k, user demographic data 92L and user psychoanalytic data 92m. The database 92 may be collocated with the application server 22d or it may be connected to the application server 22d via a communication network, such as the network 28. Various components of the database 92 are described in more detail below.

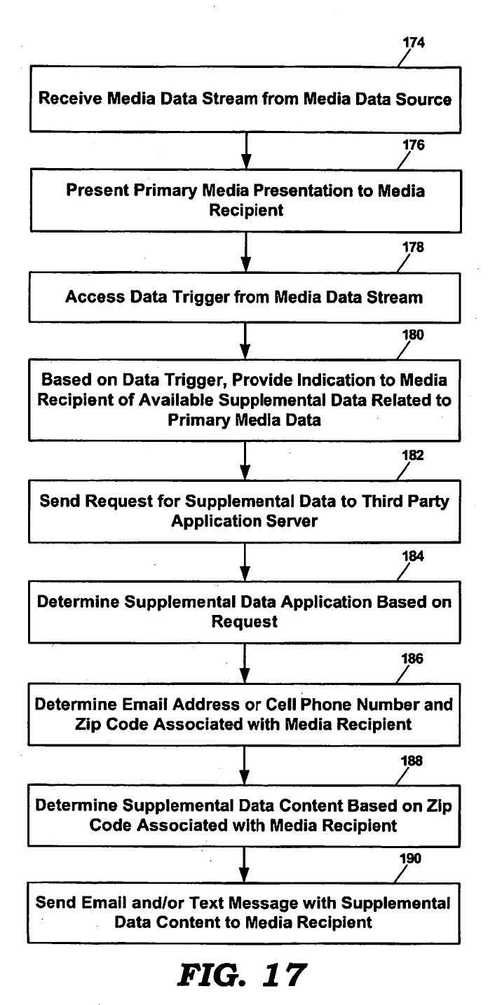

FIG. 17 depicts a method for providing supplemental data via email or text message to a recipient of a media data stream. In the following example, the media data stream is a television commercial provided to the media recipient via a satellite television receiver. However, it should be appreciated that the media data stream could be an video/audio stream from a cable television provider or Internet provider, a video/audio stream from a DVD or Bluray disk, or an audio-only stream from the Internet, a terrestrial or satellite radio source, or a CD. Thus, it will be appreciated that the invention is not limited to the exemplary embodiments described herein.

As shown in FIGS. 5B and 17, the television commercial is included in a media data stream 14 provided by a satellite television provider 12, such as DirecTV, and received by a satellite television receiver 16 associated with a media recipient (step 174). The television commercial, which is the primary media data of this example, is displayed on the consumer's television display device 20 (step 176). Embedded in the media data stream is a data trigger which indicates the availability of supplemental data that is related to the primary media data. When the satellite television receiver 16 detects the data trigger (step 178), it generates a graphic icon that is displayed on the television display device 20 during the commercial (step 180). This graphic icon indicates to the media recipient that further information is available about a product or service depicted in the television commercial.

If the media recipient presses a particular button on the satellite receiver remote control while the icon is displayed, the satellite receiver 16 generates a request packet that is sent from the satellite receiver 16 via the communication link 24e, the Internet 28 and the communication link 24i to the third-party application server 22d (step 182). In preferred embodiments of the invention, the request packet includes the identification number that identifies the particular satellite television receiver 16 from which the packet originated and a number that identifies the enhancement for the television commercial displayed at the time the packet was generated. The third-party application server 22d extracts the identification number and enhancement number from the request packet, accesses the database 92 and determines based on the enhancement number which application specification 92h is to be applied for this request (step 184). The server 22d also determines the email address and zip code associated with the identification number extracted from the request packet (step 186). In some embodiments, the server 22d also accesses the user cell phone number portion 92k of the database 92 to determine the cellular telephone number associated with the identification number extracted from the request packet.

The third-party application server 22d determines based on the application specification what sort of supplemental data is to be provided to the media recipient. For example, the application specification may be associated with a General Motors advertisement for a particular new car model, and the specification may indicate that a PDF copy of a brochure for the new car model and/or a video clip showing further features of the car is to be emailed to the media recipient. The brochure and video clip may be part of a national GM advertising campaign, and may be stored with the national/global advertiser content portion 92e of the database 92.

Based on the application specification and the zip code associated with the identification number, the server 22d determines whether local advertiser content 92f is available for the particular zip code (step 188). For example, the local advertiser content 92f may comprise special pricing and inventory information for the car that is being offered by a local dealer located in or near the particular zip code.

The server 22d then generates an email that includes the national advertising content and the local advertising content, and sends the email to the email address associated with the particular media recipient (step 190). As a result of this zip code enhancement feature, a media recipient in Knoxville, Tenn., for example, may receive different local advertising content in an email than would a media recipient in Johnson City, Tenn. Thus, the invention provides for location-specific advertising content to be sent to the media recipients.

In some embodiments, the server 22d also, or alternatively, generates a text message according to Short Message Service (SMS) or Multimedia Messaging Service (MMS) protocol which includes the advertising content. This text message is then transmitted to the cell phone number stored in the user cell phone number portion 92k of the database 92.

In this hierarchal advertising content system, an upper level of a company, such as GM, will notify individual dealerships or divisions that they can add their own content to the database 92. The upper level will decide which dealership or division gets which zip code. The assigned zip codes are then associated with the individual dealership's or division's account set up on the third-party server 22d. Once this is in place, the lower-level divisions can store and link their specific email or text message content so the server 22d can find it and generate the location-specific emails or text messages.

In one embodiment of the invention, when a media recipient pushes the button on the remote control to request supplemental information while viewing (or listening to) media content, an email and/or text message will be generated as described above that contains information about the product or service shown in the media content. In this embodiment, the email and/or text message also includes advertising information from local advertisers that have registered with the third-party server 22d to target their advertising to media recipients in particular locations. This additional advertising information may have no relation to the product or service that was shown in the media content. When the media recipient clicks on a link in the email or text message associated with local advertiser, the media recipient will be directed to a web page maintained on the third-party server 22d that is dedicated to the particular local advertiser. On this page, the media recipient may receive access to coupons from the local advertiser or a link to the local advertiser's website.

When a local advertiser registers with the third-party server 22d to take part in the local advertising network, the local advertiser will select a category for their business. These categories will be included in a directory that allows users of the system to search and keep up with their favorite local businesses. A link to this directory may be provided in the email and/or text message along with the links to the local advertisers.

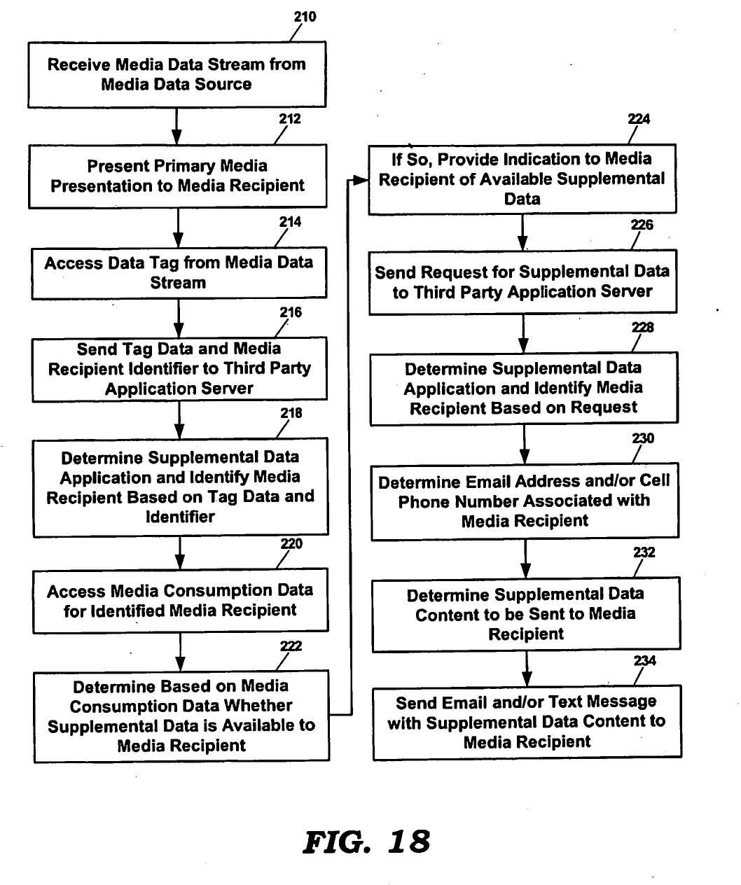

The process described above is an example of a “passive” system for providing supplemental data to a media recipient. It is passive in the sense that the system takes no action with regard to the supplemental data unless the media recipient “opts in” by pressing the button on the remote control when the icon is present on the television screen. Other processes, such as the one depicted in FIG. 18, are “active” systems which initiate a process without any action required by the media recipient.

FIG. 18 depicts another method for providing supplemental data via email and/or text message to a recipient of a media data stream. In the following example, the media data stream is a television program provided to the media recipient via a satellite television receiver. However, it should be appreciated that the media data stream could be an video/audio stream from a cable television provider or Internet provider, a video/audio stream from a DVD or Blu-ray disk, or an audio-only stream from the Internet, a terrestrial or satellite radio source, or a CD.

With reference to FIGS. 5B and 18, the television program is included in a media data stream 14 provided by a satellite television provider 12 and received by a satellite television receiver 16 associated with a media recipient (step 210). The television program, which is the primary media data of this example, is displayed on the consumer's television display device 20 (step 212). Embedded in the media data stream is a data tag which indicates the availability of supplemental data that is related to the primary media data. When the satellite television receiver 16 detects the data tag (step 214), it automatically generates a data packet that is sent from the satellite receiver 16 via the communication link 24e, the Internet 28 and the communication link 24i to the third-party application server 22d (step 216). In preferred embodiments of the invention, the data packet includes the identification number that identifies the particular satellite television receiver 16 from which the packet originated and a number that identifies the enhancement for the television program displayed at the time the data packet was generated. The third-party application server 22d extracts the identification number and enhancement number from the data packet, accesses the database 92 and determines based on the enhancement number which application specification 92h is to be applied (step 218).

Based on information provided in the application specification, the server 22d accesses the media consumption data 92c for the particular media recipient associated with the identification number provided in the data packet (step 220). The media consumption data 92c may indicate, for example, the total elapsed time during which the media recipient's satellite receiver has been tuned to a particular television program during the last 12 months. Based on the media consumption data, the server 22d determines whether supplemental data is to be made available to the media recipient (step 222). For example, if the total elapsed time mentioned above is greater than some threshold amount, the media recipient may qualify to receive supplemental data that is not available to others who view the program less often.

If the server 22d determines that supplemental data is to be made available to the media recipient, the server 22d generates an alert packet that is sent via the communication link 24i, the Internet 28, and the communication link 24e to the satellite television receiver unit 16 (step 224). Upon receipt of the alert packet, the receiver unit 16 generates a graphic icon that is displayed on the television display device 20 during the television program (step 224). This graphic icon indicates to the media recipient that further information is available about a product or service depicted in the television program.

If the media recipient presses a particular button on the satellite receiver remote control while the icon is displayed, the satellite receiver 16 generates a request packet that is sent from the satellite receiver 16 via the communication link 24e, the Internet 28 and the communication link 24i to the third-party application server 22d (step 226). In preferred embodiments of the invention, the request packet includes the identification number that identifies the particular satellite television receiver 16 from which the packet originated and a number that identifies the enhancement displayed at the time the packet was generated.

The third-party application server 22d extracts the identification number and enhancement number from the request packet, accesses the database 92 and determines based on the enhancement number which application specification 92h is to be applied for this request (step 228). The server 22d also determines the email address and/or cell phone number associated with the identification number extracted from the request packet (step 230). Based on the application specification and the user media consumption data 92c, the third-party application server 22d determines what sort of supplemental data is to be provided to the media recipient. For example, if a media recipient has watched the particular television program for more than 50% of the elapsed time it has been shown, the media recipient may receive an email and/or text message containing supplemental data that is different from the supplemental data sent to less loyal viewers of the program. The server 22d then generates an email and/or text message that includes the supplemental data, and sends the email and text message to the email address and cell phone number associated with the particular media recipient (step 234).

For example, a data tag is embedded during a portion of the Oprah show wherein Oprah is discussing the latest book featured in her book club. A data packet is then automatically generated by each of the satellite and cable receiver units tuned in to the Oprah show at that time, and these data packets are sent via the Internet to the third-party application server 22d. For each data packet received, the server 22d accesses the media consumption data for the associated media recipient and determines the total time that the media recipient's cable or satellite receiver has been tuned to the Oprah show. For those that have been tuned in for over 50% of the time, a first type of alert packet is sent to their satellite or cable receiver units. For those that have been tuned in for 20%-49% of the time, a second type of alert packet is sent to their satellite or cable receiver units. For those that have been tuned in for less than 20% of the time, no alert packet is sent and no graphic icon is displayed.

When the alert packets are received at the satellite or cable receiver units, a graphic icon is generated and displayed indicating that supplemental data related to the book is available. In one embodiment, text is also displayed with the graphic icon indicating that a 30% off coupon (for the first type of alert packet) or a 15% off coupon (for the second type of alert packet) is available. This text may be contained in the alert packet. In another embodiment, the same text is displayed with the graphic icon, and the media recipient also receives the supplemental data email and/or text message, where the message may be different for different recipients. Viewers who wish to receive the supplemental data press the button on their remote control, and the satellite or cable receiver units generate request packets and send the request packets to the server 22d. The request packets identify the satellite or cable receiver unit from which it originated and indicate whether the alert packet received was of the first or second type. Using this information, the server 22d sends emails and/or text messages containing a 30%-off coupon for the book purchase to media recipients that watched Oprah over 50% of the time and 15%-off coupons to those that watched 20%-49% of the time.

It will be appreciated that all of the data sets stored in the database 92 could be used in both the passive enhancement and active enhancement modes. For example, the user consumption data 92c could be used passively to deliver different coupons to different viewers in emails or text messages. The same consumption data could also be used actively so that the availability of supplemental information is only revealed to those viewers that match a criteria, or the on-screen text displayed with the graphic icon is different for different viewers.

In some embodiments of the invention, the content of emails and text messages sent to media recipients varies depending on whether the television program is being watched live or recorded. The server 22d would make the determination of live versus recorded based on timestamp information provided in the request packet generated by the satellite or cable receiver unit. If live/recorded is one of the parameters included in the application specification 92h, then the supplemental data included in an email or text message could vary based on this parameter. In one embodiment, if the program is not watched live, no email or text message is generated.

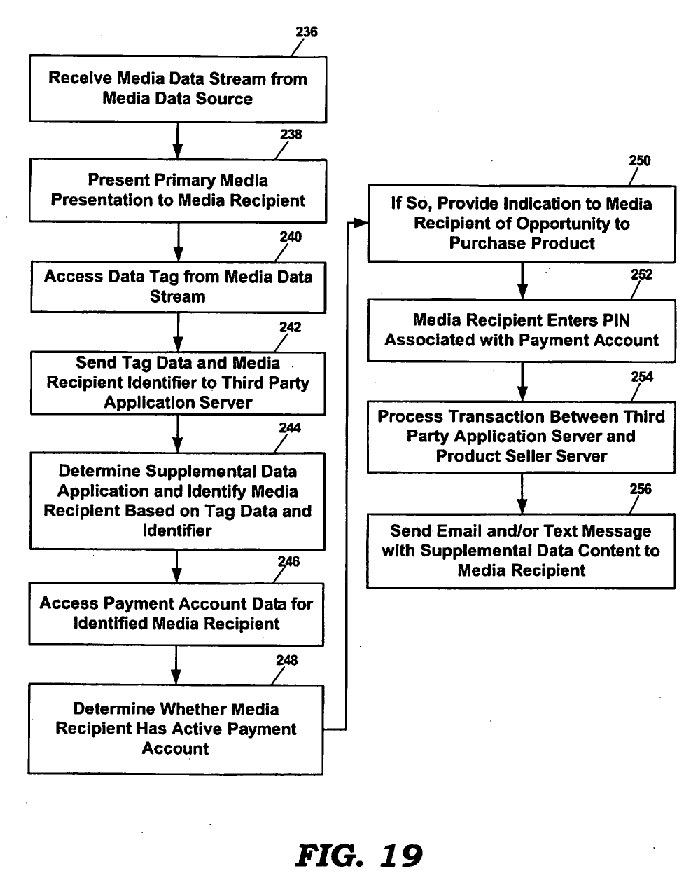

FIG. 19 depicts a method for providing supplemental data to allow the immediate purchase of a product depicted in a media data stream. In the following example, the media data stream is a television commercial provided to the media recipient via a satellite television receiver. However, it should be appreciated that the media data stream could be an video/audio stream from a cable television provider or Internet provider, a video/audio stream from a DVD or Blu-ray disk, or an audio-only stream from the Internet, a terrestrial or satellite radio source, or a CD.

With reference to FIGS. 5B and 19, the television commercial is included in a media data stream 14 provided by a satellite television provider 12 and received by a satellite television receiver 16 associated with a media recipient (step 236). The television commercial, which is the primary media data of this example, is displayed on the consumer's television display device 20 (step 238). Embedded in the media data stream is a data tag which indicates the availability of supplemental data related to the primary media data. When the satellite television receiver 16 detects the data tag (step 240), it automatically generates a data packet that is sent from the satellite receiver 16 via the communication link 24e, the Internet 28 and the communication link 24i to the third-party application server 22d (step 242). In preferred embodiments of the invention, the data packet includes the identification number that identifies the particular satellite television receiver 16 from which the packet originated and a number that identifies the television commercial displayed at the time the data packet was generated. The third-party application server 22d extracts the identification number and enhancement number from the data packet, accesses the database 92 and determines based on the enhancement number which application specification 92h is to be applied (step 244).

Based on information provided in the application specification, the server 22d accesses the payment account data 92d for the particular media recipient associated with the identification number provided in the data packet (step 246). Based on payment account data 92, the server 22d determines whether the media recipient has an active and valid payment account, with a credit card number or other monetary account number on file (step 248). If the server 22d determines that a payment account is set up, the server 22d generates an alert packet that is sent via the communication link 24i, the Internet 28, and the communication link 24e to the satellite television receiver unit 16. Upon receipt of the alert packet, the receiver unit 16 generates a graphic icon that is displayed on the television display device 20 during the television commercial (step 250). This graphic icon indicates to the media recipient that the product depicted in the television program may be immediately purchased.

If the media recipient opts to make a purchase by pressing the button on the remote control, the satellite receiver unit generates a dialog box which is displayed on the television screen. The media recipient may then identify themselves by selecting their name from a list in the box. For example, there may be several family members in a household who are registered with the server 22d and have payment accounts set up. Once the media recipient has selected his or her name, the satellite receiver unit generates a PIN entry box which is displayed on the television screen. The media recipient then uses the remote control to enter the PIN for payment account (step 252). A media recipient identifier and the PIN are sent to the server 22d for confirmation, and the server 22d handles the processing of the product purchase transaction (step 254). For example, the server 22d may communicate with a server of the product seller and provide an identifier for the specific product ordered. This product identifier may be contained in the application specification 92h stored in the database 92. The servers complete the transaction by exchanging account payment and shipping information, and the seller server contacts a bank server to verify payment. Once the transaction is complete, an email and/or text message is sent to the email address and cell phone number of the media recipient containing confirmation of the transaction (step 256).

In another embodiment, a text message is sent to the media recipient's cell phone requiring entry of the PIN for purchase authentication. For example, the media recipient may press the button on the remote control to initiate the purchase, which causes a text message to be sent to the recipient's phone. The recipient then replies to the text message with the PIN or password, and that information is sent to the server.

If the media recipient does not have a payment account set up, or a payment account is no longer valid, the media recipient may opt to receive an email or text message from the server 22d containing information for placing an order for the product using other means.

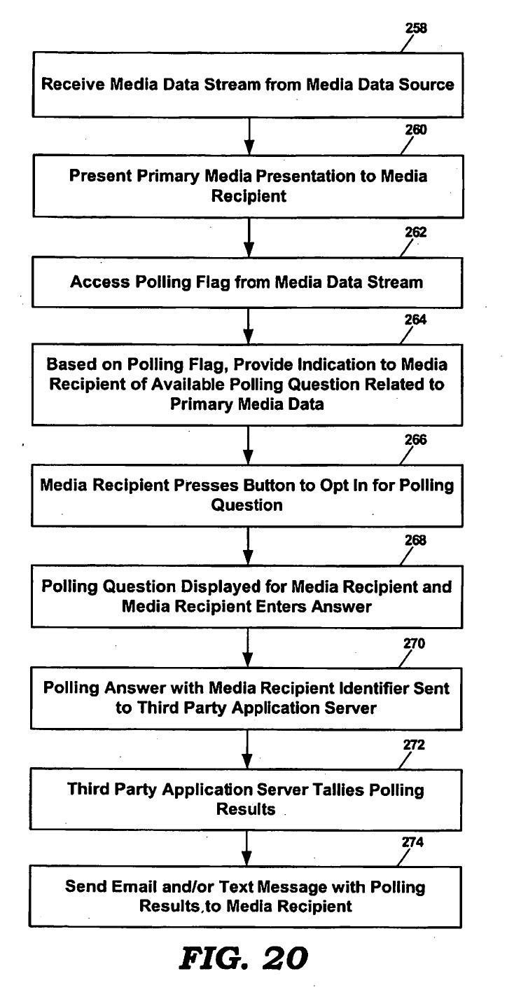

FIG. 20 depicts an embodiment of a method for providing polling questions to viewers of a television program. As shown in FIGS. 20 and 5B, the television program is included in a media data stream 14 provided by a satellite television provider 12 and received by a satellite television receiver 16 associated with a media recipient (step 258). The television program, which is the primary media data of this example, is displayed on the consumer's television display device 20 (step 260). Embedded in the media data stream is a polling flag which indicates the availability of a polling question that is related to the primary media data. When the satellite television receiver 16 detects the polling flag (step 262), it generates a graphic icon which is displayed on the television display device 20 (step 264). If the media recipient wishes to participate in the poll, the recipient presses the button on the remote control (step 266). The polling question is then displayed on the television display device 20 along with optional answers from which the media recipient may choose using the remote control (step 268). A poll response packet containing a poll question identifier, the chosen answer, and a satellite receiver unit identification number are sent to the server 22d via the Internet 28 (step 270). After some period of time, the server 22d tallies all of the responses received (step 272), and generates an email and/or text message to each participant indicating the results of the poll (step 274).

In some embodiments, the polling feature includes a quiz that is related to a television program that a media recipient is currently watching. What happens next in the program may be based on a compilation of the answers of all the media recipients watching the program. Each quiz answer is delivered to the server 22d which applies the application specification 92h for the quiz to determine what to do based on the quiz answers. For example, the server 22d may deliver further questions, end the quiz and/or send an email and/or text message to the media recipient. This feature provides content providers an opportunity to create quizzes and award different prizes based on different answers or based on a number of questions answered correctly.

Besides polling, this feature could be used to provide the media recipient a multiple-choice request for information (RFI). For example, Cadillac may run an advertisement wherein further information is offered about the coupe, the 4-door sedan or the SUV. Using the remote control and the RFI feature, the media recipient may choose to receive supplemental information about any of the vehicle models. The resulting information provided in the email and/or text message to the media recipient will vary depending on the media recipient's choice. The supplemental information may also vary depending on the media recipient's zip code and/or viewing habits, as in embodiments described above.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for transferring media information from a media data source to a media recipient, the method comprising:
(a) receiving a media data stream from the media data source, the media data stream including primary data and associated data, where the primary data comprises a primary media presentation and the associated data indicates availability of supplemental information;
(b) presenting the primary media presentation to the media recipient via a media presentation device;
(c) accessing the associated data in the media data stream;
(d) based on the associated data, providing an indication to the media recipient via the media presentation device that supplemental information is available;
(e) sending a request for delivery of the supplemental information; and
(f) sending the supplemental information in an electronic message to the media recipient.

2. The method of claim 1 wherein the request of step (e) includes a media recipient identifier, and step (f) includes accessing a database of email addresses to determine an email address associated with the media recipient identifier.

3. The method of claim 2 wherein the media recipient identifier identifies a television/computer interface device associated with the media recipient.

4. The method of claim 1 wherein the request of step (e) includes a media recipient identifier, and step (f) includes accessing a database of zip codes to determine a zip code associated with the media recipient identifier.

5. The method of claim 4 wherein step (f) includes determining content to be included in the electronic message based at least in part on the zip code associated with the media recipient identifier.

6. The method of claim 1 wherein step (f) includes determining content to be included in the electronic message based at least in part on media consumption data associated with the media recipient identifier.

7. The method of claim 1 wherein step (f) includes determining content to be included in the electronic message based at least in part on whether a user account associated with the media recipient identifier is authorized for monetary purchases of items described in the supplemental information.

8. The method of claim 1 wherein the request of step (e) includes a media recipient identifier, and step (f) includes accessing a database of cellular telephone numbers to determine a cellular telephone number associated with the media recipient identifier.

9. The method of claim 1 wherein step (f) includes determining content to be included in the electronic message based at least in part on whether the media data stream comprises live programming or recorded programming.

10. The method of claim 1 wherein
step (a) comprises receiving a video data stream from a video data source, where the primary data comprises a video presentation and the associated data indicates availability of supplemental information that is related to the video presentation;
step (b) comprises presenting the video presentation to the media recipient via a video display device;
step (c) comprises accessing data trigger information in the video data stream;
step (d) comprises displaying a graphic icon on the video display device based on the data trigger information, thereby providing an indication to the media recipient that supplemental information is available; and
step (e) comprises receiving input from the media recipient via a user input device to indicate a desire on the part of the media recipient to receive the supplemental information, and sending the request based on the input received from the media recipient.

11. The method of claim 10 wherein the video data source is selected from the group consisting of a satellite television data source, a cable television data source, a streaming video data source, a Digital Versatile Disk (DVD) player, a Blu-ray disk player, a personal media player, and a computer hard drive.

12. The method of claim 1 wherein
step (a) comprises receiving an audio data stream from an audio data source, where the primary data comprises an audio presentation and the associated data indicates availability of supplemental information that is related to the audio presentation;
step (b) comprises presenting the audio presentation to the media recipient via an audio playing device;
step (c) comprises accessing data trigger information in the audio data stream;
step (d) comprises presenting either or both of an audio icon on the audio playing device and a graphic icon on an associated video display device, wherein the presentation of the audio icon or graphic icon is based on the data trigger information, thereby providing an indication to the media recipient that supplemental information is available; and
step (e) comprises receiving input from the media recipient via a user input device to indicate a desire on the part of the media recipient to receive the supplemental information, and sending the request based on the input received from the media recipient.

13. The method of claim 12 wherein the audio data source is selected from the group consisting of a satellite radio data source, a terrestrial radio data source, a streaming audio data source, a Compact Disk (CD) player, a personal media player, and a computer hard drive.

14. The method of claim 1 further comprising:
step (a) comprises receiving a television data stream from a television data source, where the primary data comprises a television presentation and the associated data indicates availability of supplemental information that is related to the television presentation;
step (b) comprises presenting the television presentation to the media recipient via a television display device;
step (c) includes accessing the data trigger information using a television/computer interface device that receives the television data stream;
sending the data trigger information and a media recipient identifier from the television/computer interface device to a third-party application server via a communication network;
executing instructions on the third-party application server to access media recipient data associated with a media recipient identified by the media recipient identifier, where the media recipient data includes one or more of media consumption data, zip code data, user demographic data and user psychoanalytic data;
executing instructions on the third-party application server to determine the supplemental data available for the media recipient based at least in part on the media recipient data;
executing instructions on the third-party application server to generate an alert packet and to send the alert packet to the television/computer interface device; and
step (d) includes the television/computer interface device generating the graphic icon to be displayed on the television display device.

15. The method of claim 1 wherein
step (a) comprises receiving a television data stream from a television data source, where the primary data comprises a television presentation and the associated data indicates availability of supplemental information that is related to the television presentation;
step (b) comprises presenting the television presentation to the media recipient via a television display device;
step (c) comprises accessing a polling flag in the television data stream;
step (d) comprises displaying a graphic icon on the video display device based on the polling flag, thereby providing an indication to the television recipient that a polling question is available; and
step (e) comprises receiving input from the media recipient via a user input device to indicate a response from the media recipient regarding the polling question, and sending the request based on the input received from the media recipient.

16. The method of claim 1 wherein the electronic message is an email message.

17. The method of claim 1 wherein the electronic message is a text message.

18. A method for transferring media information from a media data source to a media recipient, the method comprising:
(a) receiving a media data stream from the media data source, the media data stream including primary data and associated data, where the primary data comprises a primary media presentation and the associated data indicates availability of supplemental information;
(b) presenting the primary media presentation to the media recipient via a media presentation device;
(c) accessing the associated data in the media data stream;
(d) based on the associated data, providing an indication to the media recipient via the media presentation device that supplemental information is available;
(e) sending a request for delivery of the supplemental information, where the request includes a media recipient identifier;
(f) accessing a database of message destinations to determine message destination associated with the media recipient identifier;
(g) accessing a database of zip codes to determine a zip code associated with the media recipient identifier;
(h) determining content to be included in an electronic message based at least in part on the zip code associated with the media recipient identifier; and
(i) sending the supplemental information in the electronic message to the message destination associated with the media recipient.

19. The method of claim 18 wherein the electronic message is an email message and the message destination is an email address.

20. The method of claim 18 wherein the electronic message is a text message and the message destination is a cellular telephone number.

21. An media interface apparatus for receiving media information from a media data source and providing a media recipient access to the media information, the apparatus comprising:
means for receiving a media data stream from the media data source, where the media data stream includes primary data and associated data, where the primary data comprises a primary media presentation and the associated data indicates availability of supplemental information;
means for outputting the primary media presentation to a media presentation device for presentation to the media recipient;
means for accessing the associated data in the media data stream;
means for generating an indication to be provided to the media recipient via the media presentation device, where the indication is based on the associated data and indicates that supplemental information is available;
means for receiving input from the media recipient to request the supplemental information; and
means for generating and transmitting a request for delivery of the supplemental information.

22. The media interface apparatus of claim 21 further comprising means for determining content to be included in the supplemental information based on the request, wherein the determination of the content of the supplemental information is based on one or more of an email address associated with the media recipient, a cellular telephone number associated with a media recipient, a zip code associated with the media recipient, media consumption data associated with the media recipient, whether a user account associated with the media recipient is authorized for monetary purchases of items described in the supplemental information, and whether the media data stream comprises live programming or recorded programming.

23. The media interface apparatus of claim 21 further comprising means for generating an electronic message containing the supplemental information and transmitting the electronic message to the media recipient.
